(19) United States
(12) Patent Application Publication
(10) Pub. No.: US 2026/0046549 A1
(43) Pub. Date: Feb. 12, 2026

(54) ACOUSTIC DEVICE

(71) Applicant: ALPS ALPINE CO., LTD., Tokyo (JP)

(72) Inventor: Ryo ITO, Fukushima (JP)

(21) Appl. No.: 19/247,507

(22) Filed: Jun. 24, 2025

(30) Foreign Application Priority Data
Jul. 3, 2024 (JP) 2024-107123

(51) Int. Cl. H04R 1/28; H04R 1/02; H04R 1/08; H04R 19/04

(52) U.S. Cl. CPC H04R 1/2807; H04R 1/021; H04R 1/086; H04R 19/04

(57) ABSTRACT

An acoustic device that includes: a support; and a microphone. The microphone is supported by the support. A sound collecting space is formed in front of the microphone. A front end of the sound collecting space is a sound collecting hole communicating with an external space. A shape of a cross section of the sound collecting space taken in a direction perpendicular to a center line extending in a longitudinal direction is uniform.

### CROSS-REFERENCE TO RELATED APPLICATIONS

The present application is based on and claims priority to Japanese Patent Application No. 2024-107123 filed on Jul. 3, 2024, the entire contents of which are hereby incorporated by reference.

### BACKGROUND

### 1. Field of the Invention

The present disclosure relates to an acoustic device for collecting sound using a microphone supported by a support.

### 2. Description of the Related Art

FIGS. 1 to 3 of Japanese Laid-Open Patent Application No. 2013-179437 describe an electronic device in which a microphone is housed in a housing. In this electronic device, a microphone and a silicone rubber packing covering the microphone are held in a sleeve integral with the housing. In the packing, a thin film having a thickness sufficient for use in an electro-acoustic transducer is formed, and the open area of the microphone is covered with the thin film. A small-diameter sound collecting hole is formed in the housing at a position facing the thin film, and a space is formed between the thin film and the sound collecting hole. The thin film is vibrated by vibration of air entering the housing through the sound collecting hole, and air vibration formed by the vibration of the thin film is detected by the microphone.

### SUMMARY

The present disclosure relates to an acoustic device, including:
a support; and
a microphone, wherein
the microphone is supported by the support,
a sound collecting space is formed in front of the microphone,
a front end of the sound collecting space is a sound collecting hole communicating with an external space, and
a shape of a cross section of the sound collecting space taken in a direction perpendicular to a center line extending in a longitudinal direction is uniform.

For example, the shape of the cross section is circular.

In the acoustic device of the present disclosure, a holder including a through hole formed in the holder is arranged in the support, and the microphone is held in the through hole, and
a region in the through hole in front of a front surface of the microphone is the sound collecting space.

The holder is preferably an elastic member.

In the acoustic device of the present disclosure, the sound collecting hole is preferably covered with a cover including a plurality of through holes.

### BRIEF DESCRIPTION OF THE DRAWINGS

FIG. 1 is a vertical sectional view illustrating an overall structure of an acoustic device of an embodiment of the present disclosure;

FIG. 2 is an exploded perspective view illustrating a microphone and a holder;

FIG. 3 is a vertical sectional view illustrating an acoustic device of a comparative example; and

FIG. 4 is an explanatory graph illustrating a difference in acoustic characteristics between the acoustic device of the embodiment of the present disclosure and the acoustic device of the comparative example.

### DETAILED DESCRIPTION OF THE PRESENT DISCLOSURE

In the electronic device described in Japanese Laid-Open Patent Application No. 2013-179437, a Helmholtz resonator includes a space located in front of a microphone and a small sound-collecting hole communicating with an external space. This small-sized Helmholtz resonator functions as an acoustic low-pass filter that attenuates sound energy in a certain wavelength band centered on a resonance frequency. Therefore, in the electronic device described in Japanese Laid-Open Patent Application No. 2013-179437, there is an issue that the frequency band of air vibration that can be detected by the microphone is narrowed.

An object of the present disclosure is to solve the above existing issue, and to provide an acoustic device configured to detect a wide band of sound by a microphone and that is easy to assemble.

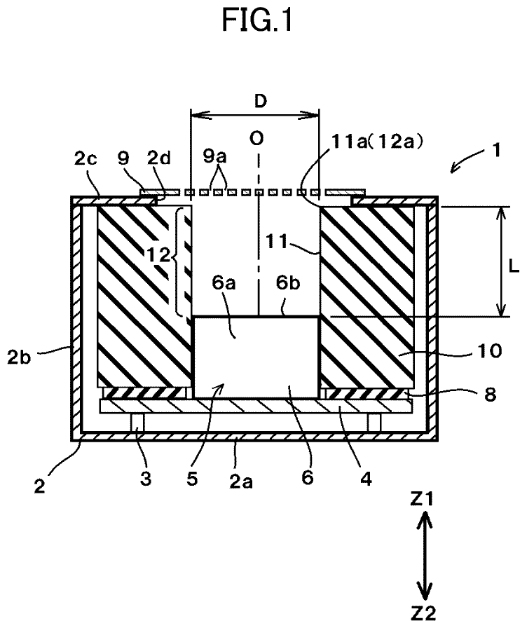

In an acoustic device 1 as illustrated in FIG. 1, a Z1-Z2 direction is a longitudinal direction, a Z1 direction is a front direction, and a Z2 direction is a rear direction. The acoustic device 1 includes a support 2. The support 2 is a housing, and includes a bottom surface 2a and a cylindrical side wall 2b arising from the bottom surface 2a. To an opening at a front end of the side wall 2b, a front surface 2c covering a part of the opening is fixed.

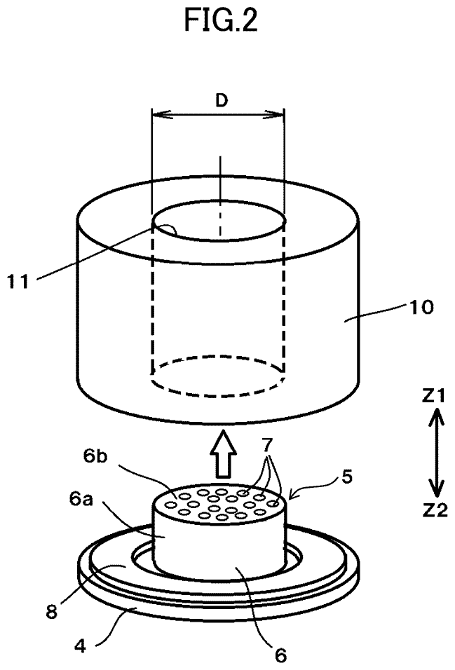

A support projection 3 is provided to an inner side of the bottom surface 2a of the support 2, and a circuit board 4 is fixed to the front of the support projection 3. A microphone 5 is mounted on a front surface of the circuit board 4. As illustrated in FIG. 2, the microphone 5 includes a case 6 formed of a thin metal plate. The case 6 includes a cylindrical portion 6a and a front surface 6b covering a front end of the cylindrical portion 6a, and multiple detection holes 7 are opened in the front surface 6b. The front surface 6b is the “front surface” of the microphone 5. The microphone 5 is of a capacitor type, and includes, inside the case 6, an insulator, a back plate fixed to the insulator, and a diaphragm located between the back plate and the detection holes 7. The back plate is a fixed electrode, and a terminal extending in the rear direction from the back plate is inserted into a through hole formed in the circuit board 4, and the terminal is soldered to an electrode layer formed on the circuit board 4. The capacitor-type microphone 5 detects a change in capacitance between the diaphragm which vibrates with sound pressure and the back plate.

A holder 10 is housed inside the support 2. The holder 10 is formed of an elastic member, and the elastic member is such as a natural rubber or a synthetic rubber, or a foamed resin such as a polyolefin or polystyrene. As illustrated in FIG. 2, a through hole 11 penetrating in the longitudinal direction is formed in the holder 10. The through hole 11 has a complete-circle cross section, and an inner diameter D is uniform throughout the longitudinal direction (Z1-Z2 direction).

As illustrated in FIG. 2, the microphone 5 is inserted into the through hole 11 of the holder 10 from a rear end of the holder 10 while being mounted on the circuit board 4. An outer diameter of the case 6 of the microphone 5 is substantially equal to or slightly larger than the inner diameter D of the through hole 11. Therefore, the case 6 of the microphone 5 is housed in the through hole 11 with almost no clearance. It is also possible to mount the microphone 5 on the circuit board 4 after mounting the microphone 5 inside the through hole 11 of the holder 10.

As illustrated in FIGS. 1 and 2, a cushion member 8 is arranged between the circuit board 4 and the holder 10. The cushion member 8 attenuates vibrations acting on the case 6 from the outside so as not to adversely affect a detecting operation of the microphone 5. Therefore, it is preferable that the cushion member 8 is formed of a material having a lower elastic modulus than that of the holder 10. However, when the holder 10 is formed of a material having a low elastic modulus such as a foamed resin, the cushion member 8 may not be used.

As illustrated in FIG. 1, after the circuit board 4, the microphone 5, and the holder 10 are housed and fixed inside the support 2, the front surface 2c is fixed to a front end of the support 2. The inner diameter of an opening 2d formed in the front surface 2c is sufficiently larger than the inner diameter D of the through hole 11 of the holder 10. The opening 2d is closed by a cover 9 including a plurality of through holes 9a.

Inside the through hole 11 of the holder 10, a space in front (Z1 direction) of a front surface of the microphone 5 (front surface 6b of the case 6) is a sound collecting space 12. A front end portion 11a of the through hole 11 is a sound collecting hole 12a, and the sound collecting hole 12a is located at the front end of the sound collecting space 12. The sound collecting space 12 communicates with the external space from the sound collecting hole 12a. The sound collecting space 12 extends from the front surface 6b to the sound collecting hole 12a, and a length L in the longitudinal direction of the sound collecting space 12 (Z1-Z2 direction) is larger than the inner diameter D. As illustrated in FIG. 1, a center line O of the through hole 11 extends in the longitudinal direction. This center line O is a center line extending in the longitudinal direction of the sound collecting space 12. The shape of the cross section of the sound collecting space 12 taken in a direction perpendicular to the center line O is uniform in the range from the front surface 6b of the microphone 5 to the sound collecting hole 12a, and the cross-sectional shape is the complete circle of the inner diameter D. A cross-sectional area of the sound collecting space 12 in the range from the front surface 6b to the sound collecting hole 12a is also uniform.

In the acoustic device 1 of the present embodiment, the sound pressure applied from the outside enters the support 2 through the through holes 9a of the cover 9, and is applied to the microphone 5 through the sound collecting hole 12a and the sound collecting space 12, and the sound pressure is detected by the microphone 5.

The sound collecting space 12 located in front of the microphone 5 is a space, in a pipe, having the uniform cross-sectional shape and the uniform cross-sectional area in the range from the front surface 6b to the sound collecting hole 12a of the microphone 5, and does not form a Helmholtz resonator. Therefore, the resonance frequency of the Helmholtz resonator does not exist in the frequency band used to detect sound by the microphone 5. The sound collecting space 12, as the space in the pipe, also has a resonance frequency, but since the sound collecting space 12 is a ¼ wavelength resonator pipe, when the length L of the sound collecting space 12 is 5 mm or less, the resonance frequency of the sound collecting space 12 does not enter the frequency band used in the sound detection by the microphone 5. In addition, when the length L of the sound collecting space 12 is 5 mm or less, a compact acoustic device 1 can be achieved.

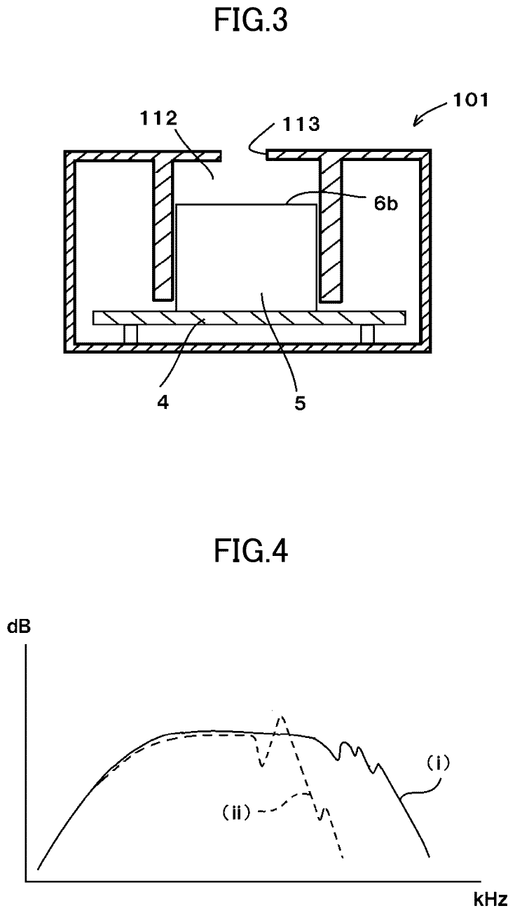

In FIG. 3, an acoustic device 101 of a comparative example is illustrated. In the acoustic device 101 of the comparative example, a sound collecting space 112 is formed in front of the front surface 6b of the microphone 5, and the sound collecting space 112 communicates with the external space through a sound collecting hole 113. The sound collecting hole 113 has a smaller diameter than an inner diameter of the sound collecting space 112. Since the sound collecting hole 113 functions as a duct, the sound collecting hole 113 and the sound collecting space 112 form a Helmholtz resonator. The acoustic device 101 of the comparative example is similar to the one described in Japanese Laid-Open Patent Application No. 2013-179437 in that it forms a Helmholtz resonator.

In FIG. 4, a difference in acoustic characteristics between the acoustic device 1 of the present embodiment and the acoustic device 101 of the comparative example is illustrated. A horizontal axis indicates the frequency of sound pressure detected by the microphone 5, and a vertical axis indicates a sound pressure level detected by the microphone 5. FIG. 4 does not illustrate measured values of actual acoustic devices, but illustrates general acoustic characteristics derived from the structure of each acoustic device. A solid line (i) in FIG. 4 illustrates the general acoustic characteristics of the acoustic device 1 of the present embodiment, and a dashed line (ii) illustrates the general acoustic characteristics of the acoustic device 101 of the comparative example. In the comparative example, a small-sized Helmholtz resonator including the sound collecting hole 113 and the sound collecting space 112 functions as the acoustic low-pass filter that attenuates the energy of sound in a certain wavelength band centered on the resonance frequency, such that the frequency band of the sound detected by the microphone 5 is narrowed, as indicated by the dashed line (ii). In contrast to this, in the present embodiment, since the sound collecting space 12 does not function as an acoustic low-pass filter in the frequency band used, the frequency band of the sound detected by the microphone 5 can be ensured widely.

As illustrated in FIG. 1, since the sound collecting space 12 is covered with the cover 9 having a plurality of through holes 9a, dust and moisture do not appreciably enter the sound collecting space 12 from the outside. Moreover, since the length L of the sound collecting space 12 is greater than the inner diameter D, even when dust and moisture enter the sound collecting space 12, they do not readily attain the front surface 6b of the microphone 5.

In the acoustic device 1 of the present embodiment, as illustrated in FIG. 2, the through hole 11 having the uniform cross-sectional shape and the uniform cross-sectional area is formed in the holder 10, and the sound collecting space 12 having a uniform cross-sectional shape can be formed in front of the microphone 5 by simply inserting the microphone 5 into the through hole 11 from the rear end of the holder 10. Therefore, a relative position of the microphone 5 and the sound collecting space 12 can be determined with high accuracy by a simple assembly process, and the sound collecting space 12, in which a shape of the cross section taken in a direction perpendicular to the center line O is uniform, can be readily formed in front of the microphone 5.

In addition, since the holder 10 is formed of an elastic member, a gap is not appreciably formed between the microphone 5 and an inner surface of the through hole 11 when the microphone 5 is inserted into and held in the through hole 11 of the holder 10. Furthermore, when an inner surface of the sound collecting space 12 is formed of a foamed resin, noise can be removed by the holder 10.

In the acoustic device of the present disclosure, since a cross-sectional shape of the sound collecting space formed in front of the microphone is uniform in a range from the front surface of the microphone to the sound collecting hole, the Helmholtz resonator is not formed and thus the acoustic low-pass filter does not exist. Therefore, the frequency band of sound that can be detected by the microphone can be expanded.

In the acoustic device of the present disclosure, for example, a through hole having a uniform cross-sectional shape is formed in a holder formed of an elastic member, and the microphone is held in the through hole, such that a sound collecting space having a uniform cross-sectional shape can be formed in the range from the front surface of the microphone to the sound collecting hole by a simple assembly process.

What is claimed is:

1. An acoustic device, comprising:
a support; and
a microphone, wherein
the microphone is supported by the support,
a sound collecting space is formed in front of the microphone,
a front end of the sound collecting space is a sound collecting hole communicating with an external space, and
a shape of a cross section of the sound collecting space taken in a direction perpendicular to a center line extending in a longitudinal direction is uniform.

2. The acoustic device according to claim 1, wherein
the shape of the cross section is circular.

3. The acoustic device according to claim 1, wherein
a holder including a through hole formed in the holder is arranged in the support, and the microphone is held in the through hole, and
a region in the through hole in front of a front surface of the microphone is the sound collecting space.

4. The acoustic device according to claim 3, wherein
the holder is an elastic member.

5. The acoustic device according to claim 1, wherein
the sound collecting hole is covered with a cover including a plurality of through holes.
